(19) United States
(12) Patent Application Publication
(10) Pub. No.: US 2023/0022623 A1
(43) Pub. Date: Jan. 26, 2023

(54) DEVICE FOR ADJUSTING THE INCLINATION OF AN OBJECT

(71) Applicant: ENDEPRO GmbH, Redwitz a.d. Rodach (DE)

(72) Inventor: Alexander Popp, Redwitz a.d. Rodach (DE)

(21) Appl. No.: 17/782,809

(22) PCT Filed: Dec. 5, 2019
(86) PCT No.: PCT/IB19/60468

§ 371 Date: Jun. 6, 2022

(51) Int. Cl. F16H 21/54; B62B 9/10; F16H 21/06

(52) U.S. Cl. CPC F16H 21/54; B62B 9/104; F16H 21/06

(57) ABSTRACT

The invention is directed towards a device for adjusting the height or the distance or the inclination of an object in relation to a structure to which the object is displaceably or pivotably connected, in particular for adjusting the inclination of a backrest of a pushchair in relation to the chassis thereof, comprising a pulling means which has at least one length-adjustable strand which is connected in the region of one of its ends to the structure and in the region of its other end to the object.

### REFERENCE TO PENDING PRIOR PATENT APPLICATION

This patent application claims benefit of International (PCT) Patent Application No. PCT/IB2019/060468, filed 5 Dec. 2019 by ENDEPRO GmbH and Alexander Popp for DEVICE FOR ADJUSTING THE INCLINATION OF AN OBJECT.

The above-identified patent application is hereby incorporated herein by reference.

### FIELD OF THE INVENTION

The invention is directed to a device for adjusting the height or the distance or the inclination of an object in relation to a structure to which the object is displaceably or pivotably coupled, for example as a device for adjusting the inclination of a backrest of a stroller in relation to its chassis, the coupling of the object to the structure comprising a traction means having at least one strand whose free length is adjustable, and which in the region of one of its ends is connected to the structure, and in the region of its other end is connected to the device that is fixed to the object to be adjusted, and which during the adjustment has the tendency to be automatically shortened.

### BACKGROUND OF THE INVENTION

The adjustment of the backrest of a seat typically takes place by means of a rod assembly and a gearwheel or thumbwheel. In the frame of a stroller having an adjustable backrest, the back adjustment is unlocked by pulling on a portion of the rod assembly, and the backrest is then adjusted by rotating the gearwheel or thumbwheel. Since both these actions must take place at the same time, two hands are always required of an operator, which is also impractical, among other reasons, because the operator in the meantime cannot attend to the child in question.

An initial attempt to simplify the inclination adjustment of a backrest of a child seat is known from DE 10 2012 022 306 A1. The cited publication discloses a child seat comprising a frame, a seat surface, and a backrest that is pivotable with respect to the seat surface about a rearward axis. A strap runs along the rear side of the backrest, where it may be displaceably guided. This strap with its upper end is fastened to the frame of the child seat, and extends below the seat surface to the front, up to a clamping device at the front end of the frame of the child seat. When the clamping device is released, the backrest may swing backward, the strap running through the clamping device toward the rear, so that the distance between the upper end of the backrest and the frame of the child seat may increase while the backrest is adjusted into the reclining position. In contrast, if the backrest is swiveled upwardly into an upright sitting position, the free end of the strap must be pulled, and the clamping device is once again clamped in each case after reaching the desired setting in order to lock the set position of the backrest. However, such an adjustment always requires two hands: the clamping element must be operated with one hand and the strap length shortened if necessary, while setting the backrest must take place using the other hand.

WO 20178160144 A1 describes a seat for a stroller, comprising a chassis, a seat surface, and a backrest. Although the unlocking of the backrest adjustment takes place at the rear side of the backrest, so that an adjustment may possibly be made with only one hand, the locking in turn takes place via a clamp, which over the long term is unreliable. In addition, a portion of the adjustment device, namely, an elastic band, extends outside the housing and runs along the entire rear side of the seat, which complicates the overall arrangement significantly.

### SUMMARY OF THE INVENTION

The disadvantages of the described prior art have resulted in the object of the invention, to refine a generic device in such a way that only a few brief or rapid hand movements are necessary for adjusting the distance or the inclination of an object in relation to a structure; the device is to be consistently reliable, with the simplest possible design, installation, and operation.

This object is achieved via a traction means having at least one length-adjustable strand which in the region of one of its ends is connected to the structure, and in the region of its other end is connected to the object to be adjusted, and which during the adjustment has the tendency to be automatically shortened; in the frame of the device, locking of a set length of the adjustable strand is provided, which is brought about by elements that interlock in a form-fit manner.

Since on account of this measure a traction means is used instead of a gear for absorbing forces, on the one hand the overall arrangement is simplified, and on the other hand it is not necessary to provide self-locking, so that forced-balanced transmission may also be dispensed with. In the adjustment mode, the tendency to automatically shorten at least one free strand of the traction means ensures that two manipulations are completely sufficient for an adjustment, namely, selecting the adjustment mode on the one hand, and on the other hand specifying the desired height or the desired distance or the desired inclination of an object in relation to a structure. In many cases, these two manipulations may be performed at the same time using only one hand.

Consequently, an adjustment device may be replaced by a setting device, with the aid of which the height, inclination, or distance of an object in relation to a structure or some other component may be set once and then optionally locked in order to preserve this setting.

Another aspect of the invention is that in the frame of a generic device for adjusting the height or the distance or the inclination of an object in relation to a structure to which it is displaceably or pivotably connected, a setting device is provided [via] which in a certain, preferably manually selectable, system state a setting of the height, inclination, or distance parameter is possible, but in another system state is not, while the most recently set height, inclination, or distance parameter is locked or preserved.

As the result of this departure of the invention from an adjustment gear, neither a gear ratio nor self-locking is necessary. Therefore, the setting device may be designed in such a way that the height, inclination, or distance parameter is settable with a few brief hand movements.

In contrast to clamping, the locking of a set length of the adjustable strand via elements that interlock in a form-fit manner is permanently stable, and compared to clamping does not have a tendency toward gradual slippage.

The traction means should have an elongated, flexible design. This traction means is thus, for example, a belt, a string, a cord, or a band, a wire or a braid, or also a chain, etc. All such traction means share the common feature that tensile forces can thus be transmitted, but other forces such as pressure forces, shear forces, or bending forces cannot. As a result, with such an apparatus a height, inclination, or distance position may be specified in only one direction, while for also specifying in the other direction, for example a second apparatus with an antiparallel orientation would be required. However, often this is not necessary, namely, when forces can occur only in a single direction due to a predefined special mode of operation. For example, a backrest in the normal state is always pressed to the rear due to the pressure of a back resting against it, so that the inclination position only has to be specified with respect to further swiveling to the rear, but not with respect to swiveling to the front. Therefore, one traction means is sufficient, as a result of which the overall arrangement is very straightforward.

It has proven to be advantageous for the tendency toward automatic shortening of the adjustable strand to be brought about by a spring element, situated inside the device, which is not directly connected or coupled to the traction means that forms the adjustable strand, i.e., within the meaning of a direct transfer of force, but, rather, by use of an additional movable or movably supported intermediate element with which some other element engages in a form-fit manner during the locking in order to block a movement of the intermediate element, and thus to fix the set length of the adjustable strand. In contrast to a traction means or a spring element, a design that is suitable for a form fit may be provided for a connecting means or intermediate element created specifically for this purpose. Within the meaning of the invention, the term “form fit” means that in the locked state, one element is situated in the range of movement of another element and therefore stands in the way of its movement.

The invention allows a refinement such that the additional movable or movably supported intermediate element is designed as a winding body onto which at least a portion of the traction means is windable in such a way that the at least one length-adjustable strand is formed by a region of the traction means that is not wound onto the winding body. This is a simple method of length adjustment. When the traction means is fixed to or in the winding body, the free end cannot move relative to the surface of the winding body, and is therefore able to absorb tensile forces and transmit them to the winding body.

The traction means may be easily wound onto the winding body, for example by fixing it at one end to the winding body and from there, winding it around the winding body. The unwound section of the traction means then forms a strand that is adjustable in length, depending on how far the winding body is rotated in order to wind the traction means. With such an arrangement, upon each rotation of the winding body the free strand is shortened by a single length of the circumference of the winding body.

On the other hand, there is also the option to loop the traction means around the winding body twice, and to doubly wind the traction means with each revolution of the winding body, i.e., in such a way that two length-adjustable strands are formed by the regions of the traction means that are not wound onto the winding body. In this case, a middle region of the traction means would have to be fixed to or in the winding body, and the adjacent regions of the traction means on both sides are then, in a manner of speaking, doubly taken up and wound, and each of the two regions that is not looped around the winding body then acts as a length-adjustable strand. The advantage is that two strands that are length-adjustable in the same direction or synchronously are present which are fixable at various locations on the respective other object.

In addition, two or more traction means may also be used and wound onto the winding body in such a way that overall, two or more length-adjustable strands are formed by the regions of the two or more traction means that are not wound onto the winding body. For four strands, these may be fastened, for example, at the four corners of a plate, for example a table.

For a synchronous adjustment of two strands, it is important that they are wound onto the winding body in the same direction of rotation, so that, depending on the rotational direction of the winding body, they are both simultaneously wound or simultaneously unwound.

When two strands diverge diametrically from the winding body or are deflected in diametric directions, a course of the two strands that is symmetrical with respect to a center plane is obtained, and the strands may then be led in opposite directions to oppositely situated edges of an adjustable object, or to spaced-apart anchorings at a structure.

The invention further provides that the traction means is/are led inwardly through openings in the circumference of the winding body, and anchored in the interior of the winding body. At that location a clamping mechanism or some other anchoring mechanism does not interfere with the winding operation.

The winding body should have a rotationally symmetrical shape, in particular the shape of a circular disk. Such a shape likewise facilitates uniform winding and unwinding onto/from the winding body.

A design of the winding body such that its circumference has a center region, viewed in the longitudinal direction of its rotational axis, that is reduced in diameter and that at one or both end-face sides is delimited by a radially expanded region, then acts as a winding drum, the strand(s) being wound around the tapered region and kept from sliding down by the radial expanded regions.

To allow a uniform rotational movement of the winding body that is as precession-free as possible, the winding body should be rotatably supported about its rotational axis of symmetry, in particular at a chassis or at a housing that encloses the winding body. Depending on the design of the winding body, a single bearing location may be sufficient for this purpose, in particular when the winding body has a disk-like shape, or the bearing takes place at two bearing locations that are shifted relative to one another in the direction of the rotational axis; such an embodiment is recommended for a winding body that is drum-shaped, i.e., having a pronounced three-dimensional extension.

Further advantages result from the winding body being pretensioned by a spring in a rotational direction, in particular in the winding direction of the traction means. Due to the resulting tendency to consistently wind the largest possible section of the traction means, the at least one remaining free strand of the traction means is permanently held under tensile stress, and therefore continually follows the straightest possible line and is also always capable of counteracting a force, acting on the adjustable object, in the direction of rotation of the traction means.

The spring is preferably designed as a helical spring. Such an embodiment has the advantage that the two ends of the spring are then situated in the same spring plane, and a housing or chassis is accordingly free of bending or twisting forces.

The spring or helical spring may be situated inside the winding body, in particular for space reasons. Due to its geometric similarity, in particular a helical spring may be accommodated in a disk-shaped winding body, while a coil spring, for example, also fits in a drum-shaped winding body.

To allow a selected rotational position to be fixed, the invention provides that the winding body is provided with a locking device, and when the locking device is activated a further rotation of the winding body is blocked, preferably in both rotational directions, but at least in the rotational direction in which a torque acts when the free strand of the traction means is under tension, and which is thus to be absorbed.

To allow a selected rotational position to be locked, it is necessary to be able to absorb and divert an acting torque; in particular a form fit is suitable for this purpose, which is possible in particular when the winding body has a row of teeth running totally or partially around it. There are different shapes of teeth: In one shape of tooth similar to a gearwheel, both flanks of a tooth extend relatively steeply, i.e., practically in a radial plane, so that large torques may be transmitted; on the other hand, the shape of the tooth may also be designed in the manner of a sawtooth having a steep flank and a flat flank. High torques may then be transmitted in one rotational direction, while in the other rotational direction—in any case, for a small freedom of movement of one of the interlocking objects in the radial direction—a run-up is possible at the flatly inclined flank of the sawtooth, and thus little or no torque can be transmitted.

An engagement element provided at a chassis or housing of the device, which is suitable for engaging with the row of teeth of the winding body in order to block rotation of the winding body, may interact with such a row of teeth. For this purpose, the engagement element has an engagement area that is designed as a counterpart to one or more teeth of the row of teeth.

The engagement element preferably has one or more teeth in its engagement area. Even if these teeth in the side profile do not correspond exactly to a gap in the row of teeth, they are still able to mesh with the row of teeth and thus prevent further rotation of the winding body.

To allow a blockage of the rotation of the winding body resulting from such a tooth engagement to also be discontinued, the engagement element should be displaceable in the direction toward or away from the row of teeth of the winding body. When the engagement element is removed from the row of teeth, the winding body is freely rotatable; the rotation of the winding body is blocked in the state in which it is advanced against the row of teeth. A displacement is made possible, for example, by at least one guide element for the engagement element which is situated at the chassis or housing of the device. This may be, for example, a profile that surrounds the engagement element at multiple sides and thus leads in the longitudinal direction of the profile.

The engagement element is preferably pretensioned in a direction toward the row of teeth of the winding body, so that in the otherwise force-free state it is pulled or pushed in the direction toward the row of teeth, and its engagement area engages with the row of teeth at the winding body in order to block the latter in terms of rotational movement. In other words, if there is no active influence on the engagement element from the outside, it automatically goes into the locking state, as a result of which the height, inclination, or distance value, once set, is retained over the long term, theoretically for an unlimited period of time.

The invention [provides that] the engagement element is pretensioned by at least one spring. A spring is a passive mechanical element which requires no auxiliary energy, and which may therefore continually perform its task.

This at least one spring for pretensioning the engagement element may be formed by a tension spring or compression spring, in particular a coil spring. For this purpose, it is beneficial for the longitudinal axis of the coil spring to be parallel to the guided displacement direction of the engagement element.

Lastly, according to the teaching of the invention, the engagement element is provided with an actuating element which optionally protrudes from a housing. It is possible to release the lock at this actuating element, in particular manually, by retracting the engagement element with respect to the row of teeth of the winding body or pulling it away from the row of teeth. After being released, it is then automatically advanced back into the locking state via its built-in pretensioning spring. Since a tensile force must preferably be manually applied to the actuating element, it may have an undercut, for example as a tab having an opening oriented transversely with respect to its displacement direction. Alternatively or additionally, it is also possible to provide at least one surface region of the actuating element with profiling, or to roughen same.

### BRIEF DESCRIPTION OF THE DRAWINGS

Further features, particulars, advantages, and effects based on the invention result from the following description of one preferred embodiment of the invention, with reference to the drawings, which show the following:

FIG. 1 shows a backrest of a stroller, for example, in a schematic illustration, including a device according to the invention for changing the inclination of this backrest, which includes a manually movable actuating element;

FIG. 2 shows a section through the adjustment device from FIG. 1 along a center plane thereof which is spanned by the movement direction of the actuating element on the one hand, and an axis of symmetry of the adjustment device on the other hand; and

FIG. 3 shows a section through the adjustment device from FIG. 1 along a plane that is parallel to a base surface or mounting surface of the adjustment device.

### DETAILED DESCRIPTION OF THE PREFERRED EMBODIMENTS

The drawings illustrate a device 1 for adjusting the height, inclination, or distance of an object 2, which as an example is used for adjusting the inclination of a backrest 3 of a stroller. Of course, such a device or a similar device 1 or arrangement, with appropriate adaptation, may also be used to adjust other objects 2 with regard to their inclination and/or their distance in relation to a structure or with regard to their height, for example a front side of a desk that may be folded down to form a tabletop, an awning that may be swiveled out or extended, or also a lowerable sliding window, etc. In this regard, the illustrated application is to be understood only as an example.

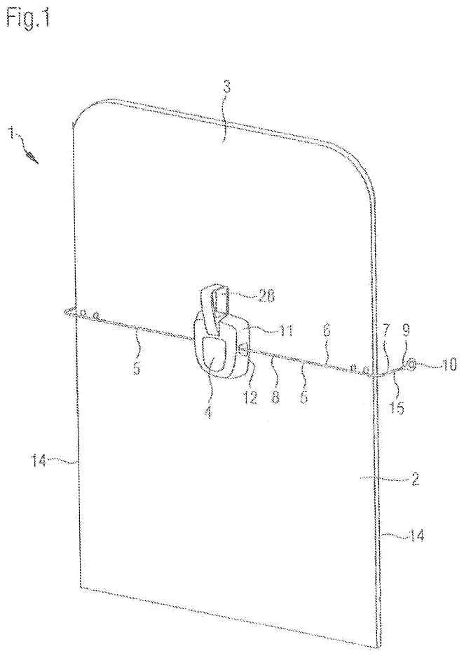

As is apparent from FIG. 1, the device 1 according to the invention has a housing 4 from which one or more strands 5 of a traction means 6 emerge.

The traction means 6 may be made up of a string, a cable, or a wire, for example. It is important that it should be flexible with regard to deformations transverse to its longitudinal direction, whereas in its longitudinal direction it should be as invariant as possible with regard to deformations, in particular elongations, i.e., preferably should not be elastically stretchable. A typical example of such could be a Nylon cord, as also used as kite line to allow kites to ascend.

Each strand 5 is preferably made of the same material. The two strands 5 discernible in FIG. 1 may come either from the same traction means 6 or from two different traction means 6, which, however, are then preferably made of the same material.

As is further apparent from FIG. 1, each strand 5 has two ends 7, 8, one of which terminates freely and which may be provided with a connecting means or fastening means 9, for example, in particular in the form of an eyelet 10. By use of such an eyelet 10, the free end 7 in question may be fastened, for example screwed, to a structure not illustrated in FIG. 1. For a stroller, such a structure could be its chassis or frame, for example. In general, however, a variety of structures are usable.

The other end 8 leads into the housing 4 of the device 1 via an opening 11 in each case. The housing 4 of the device 1 at its bottom side 12, for example, is fastened, preferably screwed, to the object 2 to be adjusted, or in the present case, the backrest 3.

Situated within the housing 4 is a mechanism 13 via which the free length of the strands 5 may be influenced. As is apparent from FIG. 1, the length of a strand 5 that is fixed to some other structure has direct influence on the distance or inclination angle of the object 2 or of the backrest 3 in relation to some other structure.

Since the distance of a side edge 14 of the backrest 3 from the housing 4 of the device 1 is constant, a change in the free length of the strand 5 has a direct influence on the length of the distal section 15 of the traction means 6 between the fastening means or the eyelet 10 on the one hand, and the side edge 14 of the backrest 3 on the other hand.

However, this distal section 15 is proportional to the distance in question between the object 2 or the backrest 3 on the one hand, and some other structure on the other hand to which the eyelet 10 is fixed.

If the object 2 or the backrest 3 is connected to the structure in question via a joint (not illustrated in FIG. 1), for example in the region between the backrest 3 and the seat surface in question or the like, the distance of the backrest from a structure can change only in a region that is spaced apart from this joint, and therefore the backrest 3 undergoes an inclination adjustment about the connection axis in question.

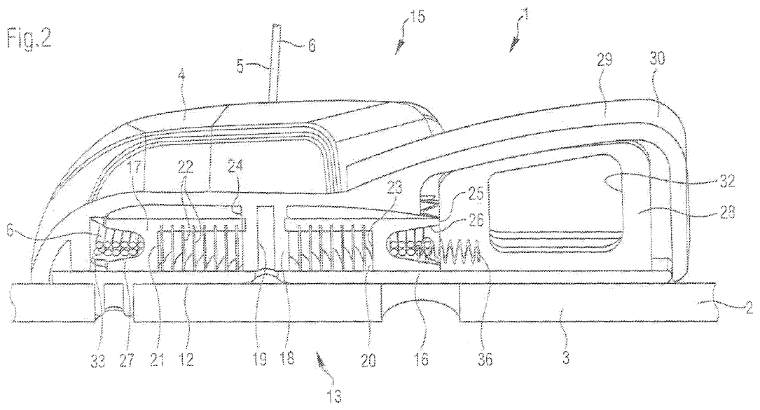

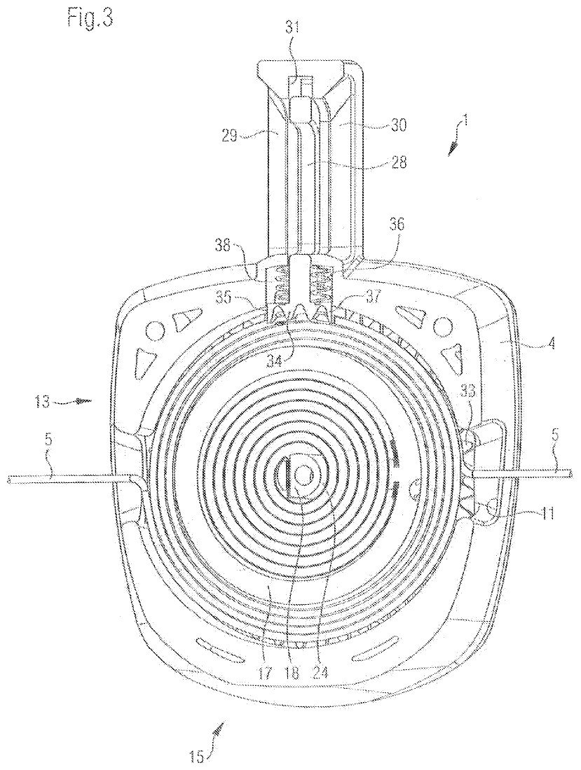

The internal design of the mechanism 13, used for the length adjustment, inside the housing 4 is shown in FIGS. 2 and 3 by way of example.

It is apparent that the mechanism 13 is covered at the top by the housing 4, whereas at the bottom it is covered by a base plate 16.

A key component of this mechanism 13 is a rotationally symmetrical portion, in particular in the form of a flat body that is used as a winding body 17 and that is rotatably supported on a central axis 18 that extends inwardly from the upper part of the housing 4.

As is further apparent from FIG. 2, it is possible to form this axis 18 with a central elongated cavity 19, so that a screw may extend through the base plate 16 and into this cavity 19, where for this purpose, for example, a female thread that matches the thread of the screw may be present.

It is further apparent from FIG. 2 that the rotoidal winding body 17 does not have a solid design, and instead has a cavity 20 that surrounds the axis 18. This cavity 20 also preferably has a flat rotoidal shape.

This cavity 20 is used to accommodate a helical spring 21, illustrated in cross section in FIG. 2; in FIG. 3 the base plate 16 is removed so that the end-face side of the spring 21 is visible and its individual windings 22 may be discerned.

The spring 21 has only two ends in total, namely, one at the outer surface of the spirally wound spring 21 or at the inner side 23 of the cavity 20, and one at the inner side of the spirally wound spring 21 or at the outer lateral surface 24 of the central axis 18.

Thus, one end of the spring 21 is fixed to the inner side 23 of the cavity 20, and the other end is fixed to the outer side 24 of the axis 18. As the result of such an arrangement, the spring 21 seeks to maintain a certain rotational angle between the rotationally symmetrical winding body 17 on the one hand, and the central axis 18 or the housing 4 of the device 1 on the other hand.

It is apparent in FIG. 2 that a circumferential indentation 26 is provided at the outer lateral surface 25 of the winding body 17, in particular in the form of a groove 27 formed along the entire circumference.

As is particularly apparent from FIG. 3, the two strands 5 of the traction means 6, after they have each entered the interior of the housing 3 through one of two diametrically opposed openings 11, are looped around the grooved lateral surface 25 of the winding body 17 or wound onto it. To prevent the strands 5 or the traction means 6 from slipping from the lateral surface 25 in question, the above-mentioned groove 27 or circumferential indentation 26, which accommodates the wound strands 5, is incorporated at that location.

The operating principle of this mechanism 13 is as follows:

If it is assumed that the free strands 5 are always tightly stretched and each has the same length I, and in addition the winding body 17 in the region of its groove 27 or its circumferential indentation 26 has a radius r, and thus a circumference U=2*π*r, under the further prerequisite that the two strands 5 are formed from the same traction means 6 having the total length L₂, which in the region of its center is fixed to the winding body 17 while its free ends 7 each form a strand 5, the following applies:

L₂=2*I+π*r+4*π*r*|α|/360°=constant,

where α is the rotational angle of the winding body 17 with respect to its position, in which the strands 5 are wound neither in one direction nor in the other direction. Forming the absolute value |α| takes into account that the traction means 6 in principle may be wound onto the traction means 19 [sic; 6] in both rotational directions.

The factor “4” takes into account the fact that both strands 5 are always wound during one rotation; i.e., for a rotation of the winding body 17 of exactly 360°, the sum of the two strands 5 of the traction means 6 is shortened overall by twice the circumference U of the winding body 17.

The term π*r describes the fact that the traction means 6 must be guided around the winding body 17 by an angle of 180°, since the two openings 11 in the housing 4 are situated diametrically opposite one another.

For two strands 5 that are formed from the same traction means 6, the length I then describes the length of the free section, i.e., the section that is detached from the flat body 6 [sic], of a strand 5, which with its ideally straight course may be easily measured as the distance of the eyelets 10 from the lateral surface 25 of the winding body 17; i.e., the following applies:

I=L₂/2−π*r/2−2*π*r*|α|/360°.

If a separate traction means 6, having length L₁, that is fastened at one end to the winding body 17 is used for each strand 5, the term π*r/2 may be omitted, and in addition if only one strand 5 is wound per revolution, the following applies:

I=L₁₋2*π*r*|α|/360°.

In other words, the further the winding body 17 is rotated, the larger the rotational angle α becomes, but also the smaller the free length I of a strand 5 becomes.

The maximum rotational angle|αₘₐₓ| is reached when one of the strands 5 is completely wound onto the outer lateral surface 25 of the winding body 17, i.e., when its free length I is equal to zero:

I=(L₂−π*r)/2−2*π*r*|αₘₐₓ|/360°=0,

2*π*r*|αₘₐₓ|/360°=(L₂−π*r)/2,

|αₘₐₓ|=360°*(L₂−π*r)/(4*π*r).

If only a single strand 5 is formed from a traction means 6, the following is obtained:

|αₘₐₓ|=360°*L₁/(2*π*r).

Due to the fact that each opening 11 preferably has a clear opening whose cross section is greater than the cross section of the traction means 6 but smaller than the cross section of an eyelet 11 or some other end-side fastening means 9, these ends 7, 8 cannot enter into the interior through the openings 11, which may possibly facilitate the installation.

The helical spring 21 should be pretensioned in such a way that it assumes its completely relaxed state not at the rotational angle α=0°, but instead, preferably at a rotational angle|α|≥|αₘₐₓ|, so that the winding body 17 is always pretensioned in a rotational direction for all conceivable rotational angles|α| |αₘₐₓ|, and thus seeks to always wind the strands 5 completely onto the winding body 17 in a predefined rotational direction until the eyelets 11 or the end-side fastening means 9 abut the edges of the openings 11.

In other words, the helical spring 21 always seeks to draw the eyelets 11 or the end-side fastening means 9 toward the housing 4. If these eyelets 11 or fastening means 9 are fixed to a structure, at least the strands 5 between this structure and the object 2 or the housing 4 affixed thereto are tightly stretched.

According to the invention, however, there is the option to select or switch between this tightening mode and some other mode, in the other mode the free length I of a strand 5 remaining constant. This may be achieved by compensating for the effect of the helical spring 21, and this may take place in particular by preventing a rotation of the winding body 17 relative to the housing 4.

An actuating element 28 that protrudes from the housing 4 of the device 1 and is thus freely accessible is used for this purpose. The actuating element enables the selection between, on the one hand, a setting mode in which the helical spring 21 is active but the rotation of the winding body 17 is not hindered, so that the height or the inclination or the distance of the object 2 in relation to a structure for tightened strands 5 may be set, and on the other hand, a locking state or use state in which a set free length I of the strands 5 is held constant by hindering further rotation of the winding body 17, so that the most recently set height or inclination or the most recently set distance of the object 2 in relation to a structure is retained, and the object in question may be used for its customary function: a backrest 3 for leaning against, for example.

The actuating element 28 is displaceably guided within the housing 4, in particular in a direction radial to the central axis 18. As is apparent from FIG. 2, the housing 4 has a lateral shoulder 29 which is designed in the manner of a bracket 30 and which is thus open on two sides. The internal length of this shoulder 29 or bracket 30 is slightly greater than the length of the actuating element 28, which results in displaceability of the latter in the radial direction with respect to the central axis 18.

As is further apparent from FIG. 3, the shoulder 29 or bracket 30 at its inner side also has a guide slot 31 in which the actuating element 28, having a disk-shaped design, which is guided in this area is movably accommodated.

The actuating element 28 preferably has a through opening 32, transverse to the plane of the actuating element, which is preferably larger than the cross section of a human finger, so that for the purpose of selecting the setting mode, a person may pass a finger through this opening 32 in order to subsequently displace the actuating element 28.

The actual selection between two different operating modes is carried out in that circumferential gear teeth 33 are provided in the region of the lateral surface 25 of the winding body 17, in particular next to the groove 27 or indentation 26 at that location, i.e., in FIG. 2 either above or preferably below same, i.e., at a shorter distance from the bottom side or installation side 12 of the housing 4 than the circumferential groove 27 or indentation 26 in the lateral surface 25 of the winding body 17.

The inner space in the housing 4 is dimensioned in such a way that these gear teeth 33 encounter no obstacle therein so that the winding body 17 may rotate freely. However, at the end of the actuating element 28 facing the central axis 18, at least one tooth 34 or a short row of teeth 35 with two or more teeth 34, for example, which project in the direction toward the central axis 18 is provided. With regard to their size and geometry, these teeth are preferably designed in such a way that they are compatible with the teeth of the circumferential gear teeth 33 at the winding body 17, i.e., may engage with those gear teeth 33.

This engagement of the gear teeth is controlled by the position of the actuating element 19:

If the actuating element 28 is moved far enough toward the axis 18, its teeth 34 engage with the circumferential gear teeth 33 of the winding body 17; the actuating element 28 that is captive in the guide slot 31 cannot itself rotate about the axis 18, and due to its gear teeth engagement with the winding body 17 likewise does not allow the latter to rotate; the winding body 17 is locked in the rotational direction.

In contrast, if the actuating element 19 is far enough away from the axis 18, its teeth 34 no longer reach the circumferential gear teeth 33 of the winding body 17, and there is no gear teeth engagement. The winding body 17 is free and is able to rotate, at least until one or both or all strands 5 are stretched, in particular under the influence of the helical spring 21.

However, the two end positions of the actuating element 28 do not have an equally stable design. Apparent in FIGS. 2 and 3 at the side, next to the center plane of the actuating element 28 having a partially disk-shaped design, are two springs 36 whose longitudinal axes are parallel to the guided displacement direction of the actuating element 28, i.e., approximately radial with respect to the axis 18.

As is apparent in FIG. 3, the row of teeth 35 of the actuating element 28 is wider than its rearward, disk-shaped, externally accessible region. To ensure the radial movability of this widened region 37 carrying the row of teeth 35, within the housing 4 a chamber 38 is created whose cross section transverse to the permitted radial displacement direction of the actuating element 28 is sufficiently large to give enough room to the widened region 37 for a radial adjustment.

Within this chamber 38, space for the springs 36 is present behind the row of teeth 35 or radially outside the widened region 37. These springs are designed as compression springs, and at their radial outer ends are supported on the housing 4; thus, they seek to press the widened region 37, carrying the row of teeth 35, radially inwardly in the direction toward the central axis 18.

As soon as the actuating element 28 is released, it is thus pressed radially inwardly by the springs 36, and the engagement of the teeth 34 with the gear teeth 33 at the outer circumference of the winding body 17 is established, and the flat body is consequently locked from further rotation. This corresponds to the use position in which the set free length of the strands 5 cannot change. If the object 2, for example a backrest 3 of a seat, is now pressed away from a structure opposite the direction of the stretched end-side sections 14 of the strands 5, the strands 5 in this locking position are then able to absorb the forces that occur, without the object 2 yielding to this external force.

For setting a free length I of the strands 5, the actuating element 28 is initially pulled radially outwardly until the winding body 17 is released and can rotate freely, still only under the internal influence of the helical spring 21.

If the object 2 in question, for example a backrest 3, is now pressed down into its desired inclination position, i.e., away from the structure, the helical spring 21 enables the length I of the strands 5 necessary for this purpose; subsequent release of the actuating element 28 results in locking of this position.

On the other hand, during selection of this setting mode, if the object 2, for example a backrest 3, is lifted upwardly or moved toward a structure, the helical spring 21 winds up the portion of the strand 5 or of all strands 5 that is/are now in excess, and thus tightens the strands 5, so that the exact free length I necessary for the desired inclination position is available. After the actuating element 28 is released, the springs 36 press it inwardly up to the gear teeth engagement between the teeth 34 and the gear teeth 33; the system makes note of the set inclination position and subsequently holds it constant, even under external compression load.

List of reference numerals

| | |
|---|---|
| 1 | device |
| 2 | object |
| 3 | backrest |
| 4 | housing |
| 5 | strand |
| 6 | traction means |
| 7 | end |
| 8 | end |
| 9 | fastening means |
| 10 | eyelet |
| 11 | opening |
| 12 | bottom side |
| 13 | mechanism |
| 14 | side edge |
| 15 | distal section |
| 16 | base plate |
| 17 | winding body |
| 18 | axis |
| 19 | cavity |
| 20 | cavity |
| 21 | helical spring |
| 22 | winding |
| 23 | inner side |
| 24 | lateral surface |
| 25 | lateral surface |
| 26 | indentation |
| 27 | groove |
| 28 | actuating element |
| 29 | shoulder |
| 30 | bracket |
| 31 | guide slot |
| 32 | opening |
| 33 | gear teeth |
| 34 | tooth |
| 35 | row of teeth |
| 36 | spring |
| 37 | widened region |
| 38 | chamber |

1. A device (1) for adjusting the height or the distance or the inclination of an object (2) in relation to a structure to which the object is displaceably or pivotably coupled, for example for adjusting the inclination of a backrest (3) of a stroller in relation to its chassis, the coupling of the object (2) to the structure comprising a traction means (6) having at least one strand (5) whose free length (I) is adjustable, and which in the region of one of its ends (7) is connected to the structure, and in the region of its other end (8) is connected to the device (1) that is fixed to the object (2) to be adjusted, and which during the adjustment has the tendency to be automatically shortened, wherein in the frame of the device (1), locking of a set length (I) of the adjustable strand (5) is provided, which is brought about by elements that interlock in a form-fit manner.

2. The device (1) according to claim 1, characterized in that the tendency toward automatic shortening of the adjustable strand (5) is brought about by a spring element, situated inside the device (1), which is not directly connected to the traction means (6) that forms the adjustable strand (5), but, rather, by use of an additional movable or movably supported intermediate element with which some other element engages in a form-fit manner during the locking in order to block a movement of the intermediate element, and thus to fix the set length (I) of the adjustable strand (5).

3. The device (1) according to claim 2, characterized in that the additional movable or movably supported intermediate element is designed as a winding body (17) onto which at least a portion of the traction means (6) is windable in such a way that the at least one length-adjustable strand (5) is formed by a region of the traction means (6) that is not wound onto the winding body (19).

4. The device (1) according to claim 3, characterized in that the traction means (6) is easily windable onto the winding body (17), so that overall a length-adjustable strand (5) is formed by the region of the traction means that is not wound onto the winding body (17).

5. The device (1) according to claim 3, characterized in that the traction means (6) is windable around the winding body (17) twice, so that two length-adjustable strands (5) are formed by regions of the traction means (6) that are not wound around the winding body (17).

6. The device (1) according to claim 3, characterized in that two or more traction means (6) are windable onto the winding body (17), so that two or more length-adjustable strands (5) are formed by the regions of the two or more traction means (6) that are not wound around the winding body (17).

7. The device (1) according to claim 5, characterized in that two strands (5) are wound onto the winding body (17) in the same direction of rotation.

8. The device (1) according to one of claim 5, characterized in that two strands (5) diverge diametrically from the winding body (17) or are deflected in diametric directions, in particular in the region of the edges of openings (11) in a housing (4) that encloses the winding body (17).

9. The device (1) according to claim 3, characterized in that the traction means (6) is/are anchored at the circumference (25) of the winding body, or led inwardly through openings in the circumference (25) of the winding body (17) and anchored in the interior of the winding body (17).

10. The device (1) according to claim 3, characterized in that the winding body (17) has a rotationally symmetrical shape, in particular the shape of a circular disk.

11. The device (1) according to claim 3, characterized in that the circumference (25) of the winding body (17) has a center region (26, 27) that is reduced in diameter and that at one or both end-face sides is delimited by a radially expanded region.

12. The device (1) according to claim 3, characterized in that the winding body (17) is rotatably supported about its rotational axis of symmetry, in particular with respect to a chassis or a base plate (16) or with respect to a housing (4) that encloses the winding body (17), in particular at a central axis (18) of the housing (4).

13. The device (1) according to claim 3, characterized in that the winding body (17) is pretensioned by a spring element in a rotational direction, in particular in the winding direction of the traction means (6).

14. The device (1) according to claim 13, characterized in that the spring element is designed as a helical spring (21).

15. The device (1) according to claim 13, characterized in that the spring element or the helical spring (21) is situated inside the winding body (17), in particular inside a cavity (20) in the winding body.

16. The device (1) according to claim 3, characterized in that the winding body (17) is provided with a locking device in order to fix a rotational position.

17. The device (1) according to claim 3, characterized in that the winding body (17) has a row of teeth (33) running totally or partially around it, in particular in the region of its outer lateral surface (25).

18. The device (1) according to claim 17, characterized in that an engagement element (37) that is suitable for engaging with the row of teeth (33) of the winding body (17) is provided at a chassis, a base plate (16), and/or a housing (4) of the device (1).

19. The device (1) according to claim 18, characterized in that the engagement element (37) has one or more teeth (34), in particular in the form of a row of teeth (35), for engaging with the gear teeth (33) of the winding body (17).

20. The device (1) according to claim 18, characterized in that the engagement element (37) is displaceable in the direction toward the gear teeth (33) of the winding body (17), preferably in a radial direction with respect to a central axis (18) within the housing (4).

21. The device (1) according to claim 18, characterized in that the engagement element (37) is pretensioned in a direction toward the gear teeth (33) of the winding body (17).

22. The device (1) according to claim 21, characterized in that the engagement element (37) is pretensioned by at least one spring (36).

23. The device (1) according to claim 22, characterized in that the at least one spring (36) for pretensioning the engagement element (37) is formed by a tension spring or compression spring, in particular a coil spring.

24. The device (1) according to claim 18, characterized in that the engagement element (37) is provided with an actuating element (28) that optionally protrudes from a housing (4).

25. The device (1) according to claim 24, characterized in that the actuating element (28) has an opening (32) for passing a finger through.

26. The device (1) according to claim 24, characterized in that the actuating element (28) is linear displaceably guided, in particular within a guide slot (31) that extends along a radial plane that is spanned by the central axis (18).

27. The device (1) according to claim 26, characterized in that the guide slot (31) is formed inside a shoulder (29) or bracket (30) of the housing that extends along a radial plane that is spanned by the central axis (18).

28. The device (1) according to claim 1, characterized in that the traction means (6) has an elongated, flexible, but preferably non-stretchable design.
